(19) United States
(12) Patent Application Publication
(10) Pub. No.: US 2019/0055156 A1
(43) Pub. Date: Feb. 21, 2019

(54) BRUCITE AS A SOURCE OF MAGNESIUM OXIDE IN GLASS COMPOSITIONS

(71) Applicant: OCV Intellectual Capital, LLC, Toledo, OH (US)

(72) Inventor: Joelle Boehmer, Pataskala, OH (US)

(21) Appl. No.: 15/679,363

(22) Filed: Aug. 17, 2017

(51) Int. Cl. C03C 13/00; C03C 3/112

(52) U.S. Cl. CPC C03C 13/006; C03C 3/112

(57) ABSTRACT

Glass fibers suitable for textile and reinforcements are described. The glass fibers have compositions that include SiO₂, CaO, Al₂O₃, and MgO. A significant amount of the MgO is derived from the mineral brucite. In some instances, the compositions are essentially free of fluorine, sulfate, and titania. These glass fiber compositions typically have broad or large values for delta T (i.e., the difference between the log 3 or forming temperature—the temperature at which the glass has a viscosity of approximately 1,000 poise—and the liquidus temperature).

### FIELD

The general inventive concepts relate to continuous glass fibers having glass compositions that include magnesium oxide (MgO), wherein the MgO is derived at least in part from brucite. The glass fibers are useful as reinforcement and textile glass fibers.

### BACKGROUND

A standard glass composition for making continuous glass fiber strands is “E” glass, which dates back to the 1940's. Despite the passing of more than seventy years, E glass, which is generally described in U.S. Pat. No. 2,334,961, is still a common glass for making textile and reinforcement glass fibers. The key advantage of E glass is that its liquidus temperature is 200° F. (93° C.) below its forming temperature, the temperature at which the viscosity of the glass is customarily near 1,000 poise.

E glass melts and refines at relatively low temperatures. E glass has a workable viscosity over a wide range of relatively low temperatures, a low liquidus temperature range, and a low devitrification rate. Generally, these glass compositions allow operating temperatures for producing glass fibers around 1,900° F. to 2,400° F. (1,038° C. to 1,316° C.) where the liquidus temperature is approximately 2,100° F. (1,149° C.) or lower. Industry typically maintains a fiber-forming temperature around 100° F. (38° C.) greater than the liquidus temperature for continuous fiber production in order to avoid devitrification in the glass delivery system and bushing.

In the mid 1970's, boron- and fluorine-containing glasses were developed which met these operating conditions. See U.S. Pat. No. 4,026,715. However, boron and fluorine in glass melts are volatile components that contribute significantly to the total emissions evolved from a glass melting operation.

Glass compositions free of boron or fluorine are known, e.g., as disclosed in British Patent Specification No. 520,427. However, such boron- and fluorine-free glass compositions posed problems.

The textile glasses as disclosed in British Patent Specification No. 520,427 melt and form at higher temperatures requiring operating conditions which could not be practically met. Devitrification (crystallization) in the bushing or during forming often occurred. For example, British Patent Specification No. 520,247 discloses glass compositions that are substantially alkaline-free containing CaO, MgO, Al₂O₃, and SiO₂, that may be modified by the addition of B₂O₃, CaF₂, P₂O₅, or a small amount of an alkali such as Na₂O, K₂O, or lithia. However, only a few of these fiberize, and only the boron-containing glasses fiberize in a continuous fiber process without difficulty. Glass No. 1 on page 2 of the British reference is one of the boron-free glasses which could be fiberized in a continuous fiber process by virtue of its 100° F. (38° C.) difference between its liquidus and forming temperatures, but its forming temperature, at 2,350° F. (1,288° C.), is too high to be formed according to earlier known processes. The viscosity of Glass No. 2 in the British reference is 1,000 poise at a temperature only 87° F. (31° C.) above the liquidus temperature. This probably would result in devitrification during forming in continuous glass fiber production. British Patent No. 520,247 teaches that this glass is preferably for insulating wool glasses, which can be formed with smaller differences between the liquidus and forming temperatures than can continuous fibers. Glass No. 3 is also preferably for insulating wool glasses. The liquidus temperature of Glass No. 3 of the British reference is 52° F. (11° C.) above the forming temperature and would crystallize in the bushing in a continuous fiber operation.

U.S. Pat. No. 4,542,106 to Sproull discloses boron- and fluorine-free glass fiber compositions. In general, they contain 58 to 60 percent SiO₂, 11 to 13 percent Al₂O₃, 21 to 23 percent CaO, 2 to 4 percent MgO, and 1 to 5 percent TiO₂. The glass fiber compositions may also contain alkali metal oxide and trace quantities of Fe₂O₃. The glasses, in addition to being free of boron and fluorine and having significant TiO₂ present, have electrical leakage characteristics such that they can be used in lieu of standard E and “621” glasses (621 glasses are generally described in U.S. Pat. No. 2,571,074). U.S. Pat. No. 3,847,627 to Erickson et al. also discloses fiberizable glass compositions that are free of boron and fluorine and contain a significant amount of TiO₂. The Erickson et al. compositions consist essentially of, by weight, 54.5 to 60 percent SiO₂, 9 to 14.5 percent Al₂O₃, 17 to 24 percent CaO, 2 to 4 percent TiO₂, 1.5 to 4 percent MgO, and 1 to 5.5 percent of ZnO, SrO, or BaO. The use of significant amounts of titania (TiO₂), however, has drawbacks. For instance, a significant amount of TiO₂ can impart an undesirable color to the glass.

To address these issues, glass compositions such as those described in U.S. Pat. No. 5,789,329 were developed. These glass compositions are generally free of boron, fluorine, sulfate, and titania. Furthermore, these glass compositions often include from 1 to 4 percent of magnesium oxide (MgO). As noted in the '329 patent, the MgO is often derived from the mineral dolomite.

However, there are many locations throughout the world where dolomite is unavailable, cost prohibitive, or otherwise difficult to obtain or process. This problem is exacerbated in glass compositions having increased MgO requirements. Accordingly, there is an unmet need for glass compositions that include MgO which is primarily derived from a source other than dolomite, for example, the mineral brucite. These glass compositions may readily be fiberized in a continuous fiber operation.

### SUMMARY

Thus, an object of the invention is to achieve economically and environmentally desirable glass fibers with advantageous properties. Another object is to prepare glass fibers of compositions having an MgO content that is primarily derived from a non-dolomite source, such as the mineral brucite. These and other objects and advantages have been achieved by the glass fibers disclosed or otherwise suggested herein.

In certain exemplary embodiments, the sulfate level is reduced in the batch in order to effectively melt and form glasses having compositions generally similar to those disclosed in British Patent No. 520,247. Such glass compositions, however, surprisingly result in larger differences between the forming and liquidus temperatures (i.e., wider delta T values). The glass composition was improved, moreover, using a process enabling successful fiberization of a glass with exceptional properties.

The glass fibers of the invention, which are suitable for textile and reinforcement glass fibers, generally have a glass composition consisting essentially of:

| Component | Amount (weight percent) |
|---|---|
| SiO₂ | 59.0 to 62.0 |
| CaO | 20.0 to 24.0 |
| Al₂O₃ | 12.0 to 15.0 |
| MgO | 1.0 to 4.0 |
| F₂ | 0.0 to 0.5 |
| Na₂ | 0.1 to 2.0 |
| TiO₂ | 0.0 to 0.9 |
| Fe₂O₃ | 0.0 to 0.5 |
| K₂O | 0.0 to 2.0 |
| SO₃ | 0.0 to 0.5 |

The total of all the components, including any trace impurities, in the composition is, of course, 100 percent by weight. The glass has a viscosity of 1,000 poise at temperatures ranging from 2,100° F. to 2,500° F. (1,149° C. to 1,371° C.), and the liquidus temperature of the glass is at least 100° F. (38° C.) below the temperature at which the fibers are formed. Despite their high-temperature operating conditions, these glasses can be fiberized without devitrification in the bushing or at forming. In some exemplary embodiments, the weight percent of MgO ranges from 2.0 to 3.5.

In another exemplary embodiment, the amounts of SiO₂, CaO, Al₂O₃, MgO, and R₂O (R₂O=Na₂O+K₂O) in these compositions are:

| Component | Weight Percent |
|---|---|
| SiO₂ | 59.0 to 61.0 |
| CaO | 21.5 to 22.5 |
| Al₂O₃ | 12.7 to 14.0 |
| MgO | 2.5 to 3.3 |
| Na₂O + K₂O | 0.1 to 2.0 |
| TiO₂ | 0.0 to 0.6 |

The viscosity of these compositions are 1,000 poise at temperatures ranging from 2,200° F. to 2,400° F. (1,204° C. to 1,316° C.) and the liquidus temperatures of these compositions are at least 125° F. (52° C.) below the temperature for a viscosity of 1000 poise.

In yet another exemplary embodiment, the amounts of SiO₂, CaO, Al₂O₃, MgO, and R₂O are as follows:

| Component | Weight Percent |
|---|---|
| SiO₂ | 59.5 to 60.5 |
| CaO | 21.7 to 22.3 |
| Al₂O₃ | 13.0 to 13.5 |
| MgO | 2.7 to 3.3 |
| Na₂O + K₂O | 0.5 to 1.0 |

In some exemplary embodiments, the TiO₂ content is not more than 0.6 weight percent, more preferably not more than 0.04 weight percent. In other exemplary embodiments, the TiO₂ content is not more than 0.6 weight percent and the F₂ content is essentially zero. In still other exemplary embodiments, the sulfate, fluorine, and titania contents are each essentially zero.

In some exemplary embodiments, continuous fiber is made having approximately the following glass composition: 60.1% SiO₂; 22.1% CaO; 13.2% Al₂O₃; 3.0% MgO; 0.2% K₂O; 0.2% Fe₂O₃; 0.1% F₂; 0.5% TiO₂; and 0.6% Na₂O. The glass has temperature characteristics on the order of log 3 of about 2,300° F. (1,260° C.), liquidus of about 2,200° F. (1,200° C.), and delta T of about 150° F. (66° C.). Such a glass also has approximately the following properties: density (of fiber; according to ASTM D1505) of about 2.62 g/ml; tensile strength at 23° C. (of pristine, unsized laboratory-produced single fiber; ASTM D2101) of about 3,100-3,800 MPa (450-550 kpsi); elastic modulus (sonic method) of about 80-81 GPa (Mpsi); elongation at breaking (of pristine, unsized laboratory-produced single fiber; ASTM D2101) of about 4.6%; refractive index (of pristine, unsized laboratory-produced single fiber; oil immersion) of about 1.560-1.562; thermal linear expansion at 00-300° C. (of bulk annealed glass; ASTM D696) of about 6.0 ppm/° C.; softening point (ASTM C338) of about 916° C.; annealing point (ASTM C336) of about 736° C.; strain point (ASTM C336) of about 691° C.; dielectric constant at 23° C. and 1 MHz (of bulk annealed glass; ASTM D150) of about 7.0; dissipation factor at 23° C. and 1 MHz (of bulk annealed glass; ASTM D150) of about 0.001; volume resistivity (of bulk annealed glass; ASTM D257; extrapolated from measurements at elevated temperatures, 120°−500° C., based on log resistivity=A/temperature+B) of about 8.1*10**26; dielectric strength at 4.8 mm thickness (of bulk annealed glass; ASTM D149) of about 8 kV/mm; percentage of original tenacity after exposure to 5% NaOH at 23° C. for 28 days (of pristine, unsized laboratory-produced single fiber) of about 30.

The MgO content of the glass compositions is primarily derived from a raw material other than dolomite. In some exemplary embodiments, at least 50% of the MgO in the glass composition is derived from brucite. In some exemplary embodiments, at least 70% of the MgO in the glass composition is derived from brucite. In some exemplary embodiments, substantially all of the MgO in the glass composition is obtained from brucite.

In some exemplary embodiments, the glass composition has an elevated level of MgO, such as greater than 4 weight percent. In some exemplary embodiments, the weight percent of the MgO in the glass composition ranges from 4 to 10. In some exemplary embodiments, the weight percent of the MgO in the glass composition ranges from 4 to 8.

### DETAILED DESCRIPTION

The glass fiber compositions of the invention include magnesium oxide (MgO) that is derived from a source other than dolomite, such as brucite. In some exemplary embodiments, the glass compositions are essentially free of boron. By “essentially free,” we mean that the composition contains at most only a trace quantity of the specified component, e.g., from impurities in the raw materials. In some exemplary embodiments, the glass fibers are also essentially fluorine-free. In some exemplary embodiments, the glass fibers are also essentially titania-free.

In general, fibers according to the invention may be prepared as follows. The components, which may be obtained from suitable ingredients or raw materials (e.g., sand for SiO₂, burnt lime for CaO, brucite for MgO) and may optionally contain trace quantities of other components, are mixed or blended in a conventional manner in the appropriate quantities to give the desired weight percentages of the final composition. The mixed batch is then melted in a furnace or melter, and the resulting molten glass is passed along a forehearth and into fiber-forming bushings located along the bottom of the forehearth. The molten glass is pulled or drawn through holes or orifices in the bottom or tip plate of the bushing to form glass fibers. The streams of molten glass flowing through the bushing orifies are attenuated to filaments by winding a strand of the filaments on a forming tube mounted on a rotatable collet of a winding machine. The fibers may be further processed in a conventional manner suitable for the intended application.

The temperatures of the glass at the furnace, forehearth, and bushing are selected to appropriately adjust the viscosity of the glass. The operating temperatures may be maintained using suitable means, such as control devices. Preferably, the temperature at the front end of the melter is automatically controlled to help avoid devitrification.

The use of sulfate in the furnace operation may help avoid seeding or bubbling problems in the glass. When producing large-scale melts, we have found it important to add carbon to the batch to control foam levels in the furnace. Preferably the sulfate-to-carbon ratio (SO₃/C) in the batch is from about 0.6 to about 1.7, in contrast with E glass, which typically runs best at an SO₃/C=3.0 to 10.0. The sulfate-to-carbon ratio is preferably controlled in the furnace to keep the foam at a manageable level and thereby allow heat to penetrate into the glass from the gas burners. It should be understood, however, that the compositions are preferably essentially free of sulfate, since this, like carbon, is almost completely or practically entirely eliminated from the glass during melting.

Furthermore, the addition of a small amount of alkali may help improve the melting rate of the batch. For example, about 0.70 weight percent Na₂O may be added to facilitate melting.

The forehearth design should be such that throughout the forehearth the glass is kept above the liquidus temperature. The forehearth should be constructed to provide for even heating of the glass to avoid cold spots causing devitrification.

The glass compositions can be readily fiberized in any suitable manner, including using known bushing technology. See U.S. Pat. Nos. 5,055,119; 4,846,865; and 5,312,470, the disclosures of which are incorporated by reference herein. Through such bushing technology, the fibers may be formed at higher temperatures with smaller differences between the forming and liquidus temperatures. In general, the bushing should be structured to provide long life and resist sagging, which is dependent on the pressure of the glass on the tip plate and the temperature. For example, the bushing can be made of a stiff alloy composition, such as one containing about 22-25% rhodium and platinum. The stiffness of the tip plate may be enhanced through the use of structural or mechanical reinforcements, such as T-gussets. The bushing screen should have high corrosion resistance, which may be accomplished, e.g., by constructing the plate screen from platinum.

The discussion above regarding parameters and equipment is provided to illustrate a process for making the inventive glass fibers. It should be understood that the artisan may suitably modify or optimize the process parameters and equipment in light of the specific glass fibers being made and conventional design considerations.

The general inventive concepts will now be illustrated through the following exemplary embodiments.

### Example I

Four production samples of reinforcement glass fibers were produced with an average glass composition analyzed as consisting essentially of, by weight: 60.01% SiO₂; 22.13% CaO; 12.99% Al₂O₃; 3.11% MgO; 0.04% F₂; 0.63% Na₂ O; 0.55% TiO₂; 0.25% Fe₂O₃; 0.14% K₂O; and 0.02% SO₃. On average, the forming temperature for a viscosity of 1,000 poise (“log 3”) was 2,298° F. (1,259° C.), the liquidus temperature was 2,146° F. (1,174° C.), and the forming-liquidus temperature difference (“delta T”) was 135° F. (57° C.).

### Example II

Using a laboratory melter, glass fibers were produced from reagents providing the following batch composition, with percentages being by weight: 60.08% SiO₂; 22.07% CaO; 13.21% Al₂ O₃; 3.01% MgO; 0.16% K₂O; 0.23% Fe₂O₃; 0.05% SO₃; 0.06% F₂; 0.52% TiO₂; and 0.60% Na₂O. The resulting glass had the following temperature properties: log 3=2309° F. (1265° C.); liquidus=2156° F. (1180° C.); and delta T=153° F. (67° C.).

### Examples III-VIII

In a manner analogous to that described in Example II, glass fibers were prepared from the batch compositions (with percentages being by weight) shown in the table below.

| Example No.: | III | IV | V | VI | VII | VIII |
|---|---|---|---|---|---|---|
| % SiO₂: | 59.45 | 61.05 | 59.05 | 59.05 | 59.45 | 59.96 |
| % CaO: | 22.69 | 22.29 | 24.29 | 22.29 | 22.69 | 22.18 |
| % Al₂O₃: | 13.48 | 13.08 | 13.08 | 15.08 | 13.48 | 13.19 |
| % MgO: | 3.23 | 2.83 | 2.83 | 2.83 | 3.23 | 3.07 |
| % K₂O | 0.63 | 0.23 | 0.23 | 0.23 | 0.23 | 0.25 |
| % Fe₂O₃: | 0.36 | 0.36 | 0.36 | 0.36 | 0.36 | 0.28 |
| % SO₃: | 0.05 | 0.05 | 0.05 | 0.05 | 0.05 | 0.05 |
| % F₂: | 0.04 | 0.04 | 0.04 | 0.04 | 0.04 | 0.09 |
| % TiO₂: | 0.04 | 0.04 | 0.04 | 0.04 | 0.04 | 0.37 |
| % Na₂O: | 0.03 | 0.03 | 0.03 | 0.03 | 0.43 | 0.55 |
| Log 3: | 2308° F. | 2334° F. | 2279° F. | 2353° F. | 2298° F. | 2310° F. |
| | (1264° C.) | (1279° C.) | (1248° C.) | (1289° C.) | (1259° C.) | (1266° C.) |
| Liquidus: | 2180° F. | 2161° F. | 2136° F. | 2227° F. | 2171° F. | 2181° F. |
| | (1193° C.) | (1183° C.) | (1169° C.) | (1219° C.) | (1188° C.) | (1194° C.) |
| Delta T: | 128° F. | 173° F. | 143° F. | 127° F. | 127° F. | 129° F. |
| | (53° C.) | (78° C.) | (62° C.) | (53° C.) | (53° C.) | (54° C.) |

### Example IX

Glass fibers were prepared having the following composition with essentially zero fluorine, sulfate, and titania levels: 61.00% SiO₂; 22.24% CaO; 12.00% Al₂O₃; 3.25% MgO; 0.52% K₂O; 0.30% Fe₂O₃; 0.00% SO₃; 0.00% F₂; 0.00% TiO₂; and 0.69% Na₂O. The glass had the following temperature characteristics: log 3=2304° F. (1262° C.); liquidus=2203° F. (1206° C.); and delta T=101° F. (38° C.).

As is understood in the art, the above exemplary compositions do not always total precisely 100% of the listed components due to statistical conventions (e.g., rounding and averaging). Of course, the actual amounts of all components, including any impurities, in a specific composition always total to 100%.

Furthermore, it should be understood that where small quantities of components are specified in the compositions, e.g., quantities on the order of about 0.05 weight percent or less, those components may be present in the form of trace impurities present in the raw materials, rather than intentionally added. Moreover, components may be added to the batch composition, e.g., to facilitate processing, that are later eliminated, resulting in a glass composition that is essentially free of such components. Thus, for instance, although minute quantities of components such as fluorine and sulfate have been listed in various examples, the resulting glass composition may be essentially free of such components, e.g., they may be merely trace impurities in the raw materials for the silica, calcium oxide, alumina, and magnesia components in commercial practice of the invention or they may be processing aids that are essentially removed during manufacture. As apparent from the above examples, glass fiber compositions of the invention have advantageous properties, such as low viscosities and wide (high) delta T values. Other advantages and obvious modifications of the invention will be apparent to the artisan from the above description and further through practice of the invention.

Notwithstanding the specific examples of glass compositions provided herein, the general inventive concepts are not intended to be limited to these specific examples but instead are applicable to any fiberizable glass compositions having an MgO content. The MgO content of the glass compositions is primarily derived from a raw material other than dolomite. In some exemplary embodiments, at least 50% of the MgO in the glass composition is derived from brucite. In some exemplary embodiments, at least 70% of the MgO in the glass composition is derived from brucite. In some exemplary embodiments, substantially all of the MgO in the glass composition is obtained from brucite.

In some exemplary embodiments, the glass composition has an elevated level of MgO, such as greater than 4 weight percent. In some exemplary embodiments, the weight percent of the MgO in the glass composition ranges from 4 to 10. In some exemplary embodiments, the weight percent of the MgO in the glass composition ranges from 4 to 8.

What is claimed is:

1. Continuous glass fiber having a composition essentially free of boron and consisting essentially of 59.0 to 62.0 weight percent SiO₂, 20.0 to 24.0 weight percent CaO, 12.0 to 15.0 weight percent Al₂O₃, 1.0 to 4.0 weight percent MgO, 0.0 to 0.5 weight percent F₂, 0.1 to 2.0 weight percent Na₂O, 0.0 to 0.9 weight percent TiO₂, 0.0 to 0.5 weight percent Fe₂O₃, 0.0 to 2.0 weight percent K₂O, and 0.0 to 0.5 weight percent SO₃, wherein the composition has (i) a viscosity of 1000 poise at a forming temperature of from 2100° F. (1149° C.) to 2500° F. (1371° C.) and (ii) a liquidus temperature at least 100° F. (38° C.) below the forming temperature; and wherein at least a portion of the MgO is derived from brucite.

2. Continuous glass fiber according to claim 1, wherein the MgO content is 2.0 to 3.5 weight percent.

3. Continuous glass fiber according to claim 1, wherein the SiO₂ content is 59.0 to 61.0 weight percent, the CaO content is 21.5 to 22.5 weight percent, the Al₂O₃ content is 12.7 to 14.0 weight percent, the MgO content is 2.5 to 3.3 weight percent, the total content of Na₂+K₂O is 0.1 to 2.0 weight percent, the TiO₂ content is 0.0 to 0.6 weight percent, the forming temperature is from 2200° F. (1204° C.) to 2400° F. (1316° C.), and the difference between the forming temperature and the liquidus temperature is at least 125° F. (52° C.).

4. Continuous glass fiber according to claim 3, wherein the SiO₂ content is 59.5 to 60.5 weight percent, the CaO content is 21.7 to 22.3 weight percent, the Al₂O₃ content is 13.0 to 13.5 weight percent, the MgO content is 2.7 to 3.3 weight percent, and the total content of Na₂+K₂O is 0.5 to 1.0 weight percent.

5. Continuous glass fiber according to claim 3, wherein the SiO₂ content is 60.1 weight percent, the CaO content is 22.1 weight percent, the Al₂O₃ content is 13.2 weight percent, the MgO content is 3.0 weight percent, and the total content of Na₂+K₂O is 0.8 weight percent.

6. Continuous glass fiber according to claim 1, wherein the TiO₂ content is not more than 0.6 weight percent.

7. Continuous glass fiber according to claim 6, wherein the TiO₂ content is 0.00 to 0.04 weight percent.

8. Continuous glass fiber according to claim 7, wherein the F₂ content is 0.00 to 0.04 weight percent.

9. Continuous glass fiber according to claim 1, wherein the composition is essentially free of TiO₂.

10. Continuous glass fiber according to claim 1, wherein the composition is essentially free of F₂.

11. Continuous glass fiber according to claim 1, wherein the composition is essentially free of SO₃.

12. Continuous glass fiber according to claim 1, wherein the SO₃, F₂, and TiO₂ contents are each no more than 0.05 weight percent.

13. Continuous glass fiber according to claim 1, wherein the difference between the forming temperature and the liquidus temperature is at least 150° F. (66° C.).

14. Continuous glass fiber according to claim 1, wherein the SiO₂ content is 60.2 weight percent, the CaO content is 22.0 weight percent, the Al₂O₃ content is 13.2 weight percent, the MgO content is 3.0 weight percent, the total content of Na₂+K₂O is 0.8 weight percent, the forming temperature is from 2200° F. (1204° C.) to 2400° F. (1316° C.), and the difference between the forming temperature and the liquidus temperature is at least 125° F. (52° C.).

15. Continuous glass fiber according to claim 1, wherein the SiO₂ content is about 60.1 weight percent, the CaO content is about 22.1 weight percent, the 3 content is about 13.2 weight percent, the MgO content is about 3.0 weight percent, the K₂O content is about 0.2 weight percent, the Na₂O content is about 0.6 weight percent, the Fe₂O₃ content is about 0.2 weight percent, the total content of SO₃ and F₂ content is about 0.1 weight percent, the TiO₂ content is about 0.5 weight percent, the forming temperature is from about 2300° F. (1204° C.) to about 2400° F. (1316° C.), and the difference between the forming temperature and the liquidus temperature is at least about 150° F. (52° C.).

16. Continuous glass fiber according to claim 1, wherein at least 50% of the MgO in the composition is derived from brucite.

17. Continuous glass fiber according to claim 1, wherein at least 70% of the MgO in the composition is derived from brucite.

18. Continuous glass fiber according to claim 1, wherein at least 99% of the MgO in the composition is derived from brucite.
